(19) United States
(12) Patent Application Publication
(10) Pub. No.: US 2016/0237630 A1
(43) Pub. Date: Aug. 18, 2016

(54) System and Method for Determining a State of Compaction

(71) Applicant: Caterpillar Paving Products Inc., Brooklyn Park, MN (US)

(72) Inventor: Benjamin Aho, Robbinsdale, MN (US)

(73) Assignee: Caterpillar Paving Products Inc., Brooklyn Park, MN (US)

(21) Appl. No.: 14/625,053

(22) Filed: Feb. 18, 2015

(51) Int. Cl. E01C 23/07; G01N 9/00; E01C 19/23

(52) U.S. Cl. CPC E01C 23/07; E01C 19/23; G01N 9/00

(57) ABSTRACT

A system for determining a state of compaction of a work material includes a roller, a speed sensor, a pitch angle sensor, and a power loss sensor. A controller determines a three-dimensional hard earth power map based upon the speed and pitch angle of the machine and the power loss and also determines a soft earth calibration factor based upon the speed and pitch angle of the machine and the power loss. The controller determines the state of compaction of the work material based upon the speed and pitch angle of the machine, the three-dimensional hard earth power map, and the soft earth calibration factor as the machine moves along the work material.

### TECHNICAL FIELD

This disclosure relates generally to machines that compact material, and more particularly, to a system and method for determining a state of compaction of a work material at a work site.

### BACKGROUND

Compacting machines or compactors are commonly used to compact work materials (such as soil, gravel, asphalt) to a desired density while constructing buildings, highways, parking lots, and other structures. In addition, compactors are often used to compact recently moved and/or relatively soft materials at mining sites and landfills. The process often requires a plurality of passes over the work material to reach the desired density.

Determining whether the desired level of compaction has been reached is often estimated in a variety of manners. In some instances, the compaction may be approximated by a state of compaction system that measures the amount of power required to move the compactor along the surface of a work site. The state of compaction system may determine a state of compaction relative to an absolute scale or a maximum amount of compaction. This type of system typically requires an operator to calibrate the machine while operating on a flat, hard surface. Operation of the machine on a slope rather than a flat surface will change the amount of power used by the machine as compared to the flat surface. As a result, the system may include an adjustment to compensate for changes due to the slope on which the machine is operating.

U.S. Pat. No. 6,188,942 discloses a method and apparatus for use with a compactor to determine the compaction performance of a material. The compaction performance may be determined as a function of the compactive energy or as a function of the propelling power of the compactor.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In a one aspect, a system for determining a state of compaction of a work material during a compaction operation includes a roller associated with a machine and configured to engage and compact the work material, a speed sensor associated with the machine operative to determine a speed of the machine, a pitch angle sensor associated with the machine operative to determine a pitch angle of the machine, and a power loss sensor associated with the machine operative to determine a power loss of the machine. A controller is configured to determine a plurality of hard earth calibration data points based upon the speed of the machine, the pitch angle of the machine, and the power loss of the machine as the machine moves along a hard earth calibration surface with the plurality of hard earth calibration data points corresponding to a plurality of different speeds and a plurality of different pitch angles. The controller is further configured to determine a three-dimensional hard earth power map based upon the plurality of hard earth calibration data points, determine at least one soft earth calibration data point based upon the speed of the machine, the pitch angle of the machine, and the power loss of the machine as the machine moves along a soft earth calibration surface, determine a soft earth calibration factor based upon the at least one soft earth calibration data point, and determine the state of compaction of the work material based upon the speed of the machine, the pitch angle of the machine, the three-dimensional hard earth power map, and the soft earth calibration factor as the machine moves along the work material.

In another aspect, a controller-implemented method for determining a state of compaction of a work material during a compaction operation includes moving a machine along a along a hard earth calibration surface at plurality of different speeds and a plurality of different pitch angles, determining a plurality of hard earth calibration data points based upon a speed of the machine, a pitch angle of the machine, and a power loss of the machine as the machine moves along the hard earth calibration surface with the plurality of hard earth calibration data points corresponding to the plurality of different speeds and the plurality of different pitch angles and determining a three-dimensional hard earth power map based upon the plurality of hard earth calibration data points. The method further includes moving the machine along a soft earth calibration surface, determining at least one soft earth calibration data point based upon the speed of the machine, the pitch angle of the machine, and the power loss of the machine as the machine moves along a soft earth calibration surface, and determining a soft earth calibration factor based upon the at least one soft earth calibration data point. The method also includes moving the machine along the work material and determining the state of compaction of the work material based upon the speed of the machine, the pitch angle of the machine, the three-dimensional hard earth power map, and the soft earth calibration factor as the machine moves along the work material.

In still another aspect, a machine includes a prime mover and a roller operatively connected to the prime mover, a roller associated with a machine and configured to engage and compact the work material, a speed sensor associated with the machine operative to determine a speed of the machine, a pitch angle sensor associated with the machine operative to determine a pitch angle of the machine, and a power loss sensor associated with the machine operative to determine a power loss of the machine. A controller is configured to determine a plurality of hard earth calibration data points based upon the speed of the machine, the pitch angle of the machine, and the power loss of the machine as the machine moves along a hard earth calibration surface with the plurality of hard earth calibration data points corresponding to a plurality of different speeds and a plurality of different pitch angles. The controller is further configured to determine a three-dimensional hard earth power map based upon the plurality of hard earth calibration data points, determine at least one soft earth calibration data point based upon the speed of the machine, the pitch angle of the machine, and the power loss of the machine as the machine moves along a soft earth calibration surface, determine a soft earth calibration factor based upon the at least one soft earth calibration data point, and determine the state of compaction of the work material based upon the speed of the machine, the pitch angle of the machine, the three-dimensional hard earth power map, and the soft earth calibration factor as the machine moves along the work material.

### BRIEF DESCRIPTION OF THE DRAWINGS

FIG. 1 depicts a diagrammatic view of a machine in accordance with the disclosure;

FIG. 2 depicts a schematic view of an exemplary drive system and an operator station for use with the machine of FIG. 1;

FIG. 3 depicts a graph of gross drive power as a function of slope for two work surfaces having different levels of compaction;

FIG. 4 depicts a block diagram of a state of compaction system;

FIG. 5 depicts a flowchart of a process for determining the state of compaction of a work surface during a compaction operation;

FIG. 6 depicts a flowchart of a hard earth calibration process of FIG. 5;

FIG. 7 depicts a three-dimensional power map of a hard earth calibration surface as a function of the speed and pitch angle of the machine; and

FIG. 8 is similar to FIG. 7 but also includes a second three-dimensional power map based upon a soft earth surface;

### DETAILED DESCRIPTION

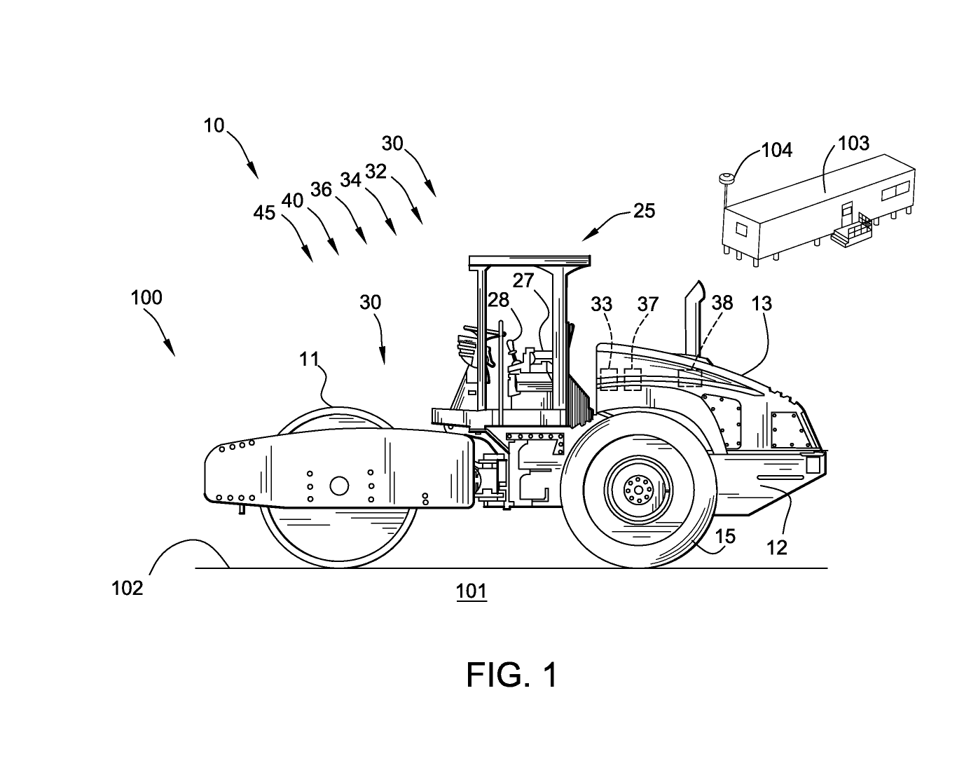

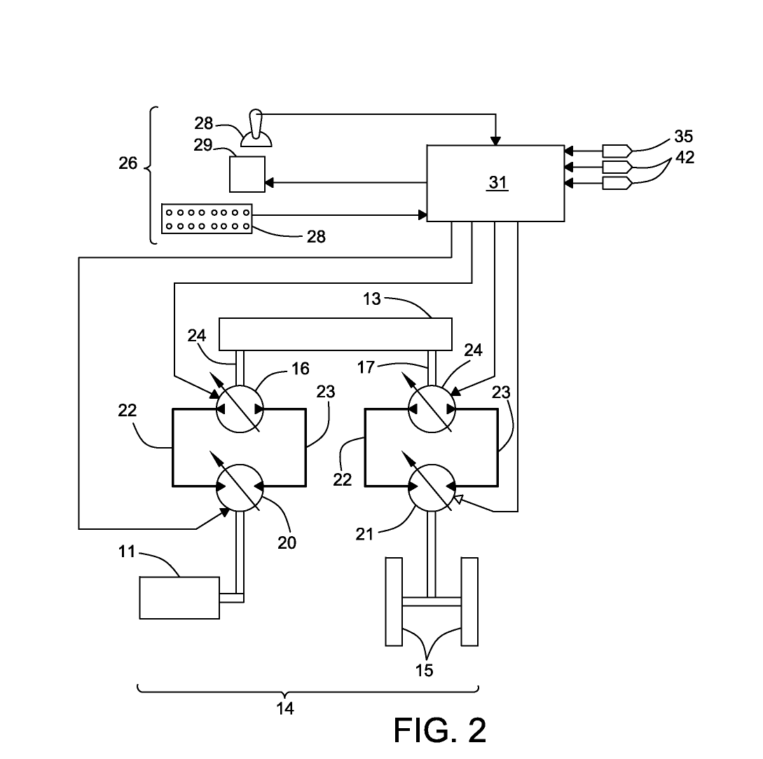

FIG. 1 depicts a diagrammatic illustration of a machine 10 such as a self-propelled single drum compactor with a single cylindrical drum or roller 11 for compacting a work material 101 at work site 100. The machine 10 includes a frame 12 and a prime mover such as an engine 13. Engine 13 is a part of a drive system 14 (FIG. 2) that propels the machine 10 as desired. The systems and methods of this disclosure may be used with any machine propulsion and drivetrain mechanisms applicable in the art including hydrostatic, electric, or mechanical drives. The drive system 14 may operate to drive roller 11 and/or one or more deflectable tires 15. In other embodiments, other types of work material engaging members may be used such as replacing the deflectable tires 15 with another roller.

In one embodiment depicted in FIG. 2, drive system 14 may be a hydrostatic system in which engine 13 is operatively connected to first pump 16 and second pump 17. Each of the first pump 16 and the second pump 17 may be operatively hydraulically connected to power first motor 20 and second motor 21, respectively, via a first hydraulic line 22 and a second hydraulic line 23. First motor 20 may be driven by pressurized hydraulic fluid from first pump 16 to rotate roller 11 and second motor 21 may be driven by pressurized hydraulic fluid from second pump 17 to rotate deflectable tires 15.

Each of first pump 16 and second pump 17 may be a variable displacement pump with the displacement controlled by controller 31. First pump 16 and second pump 17 may each direct pressurized hydraulic fluid to and from their respective motors in two different directions to operate the motors in forward and reverse directions. First pump 16 and second pump 17 may each include a stroke-adjusting mechanism, for example a swashplate, the position of which is hydro- or electro-mechanically adjusted to vary the output (e.g., a discharge pressure or rate) of the pump. The displacement of each of the first pump 16 and the second pump 17 may be adjusted so the flow is either into its first hydraulic line 22 or its second hydraulic line 23 so that the pump may drive its respective motor in either forward and reverse directions, depending on the direction of fluid flow. Each of the first pump 16 and the second pump 17 may be operatively connected to engine 13 of machine 10 by, for example, a shaft 24, a belt, or in any other suitable manner.

Each of first motor 20 and second motor 21 may be driven to rotate by a fluid pressure differential generated by its respective pump and supplied through first hydraulic line 22 and second hydraulic line 23. The flow rate of fluid into and out of the motor may determine an output velocity while a pressure differential across the pumping mechanism of the motor may determine an output torque. Each of first motor 20 and second motor 21 may be a variable displacement motor with the displacement controlled by controller 31. In another embodiment, each of first motor 20 and second motor 21 may be a fixed and/or a multi-speed motor.

Machine 10 may include an operator station 25 from which an operator may control the machine 10. Operator station 25 may include an operator interface 26 (FIG. 2) proximate an operator seat 27 through which the operator may issue commands to control propulsion and steering systems of the machine 10 as well as operate other systems and implements associated with the machine. Operator interface 26 may include a plurality of input devices 28 such as a joystick, a pedal, a push-button, a knob, a switch, or another device. The operator may manipulate an input device to affect corresponding operations of machine 10. Operator interface 26 may further include a display 29 on which various types of information useful or necessary for the operation of the machine 10 may be displayed.

Machine 10 may include a control system 30 as shown generally by an arrow in FIG. 1 indicating association with the machine 10. The control system 30 may include an electronic control module or controller 31, various input devices to control the machine 10, and a plurality of sensors associated with the machine 10 that provide data and input signals representative of various operating parameters of the machine 10. The term “sensor” is meant to be used in its broadest sense to include one or more sensors and related components that may be associated with the machine 10 and that may cooperate to sense various functions, operations, and operating characteristics of the machine.

The controller 31 may be an electronic controller that operates in a logical fashion to perform operations, execute control algorithms, store and retrieve data and other desired operations. The controller 31 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller 31 such as power supply circuitry, signal conditioning circuitry, driver circuitry, and other types of circuitry.

The controller 31 may be a single controller or may include more than one controller disposed to control various functions and/or features of the machine 10. The term “controller” is meant to be used in its broadest sense to include one or more controllers and/or microprocessors that may be associated with the machine 10 and that may cooperate in controlling various functions and operations of the machine. The functionality of the controller 31 may be implemented in hardware and/or software without regard to the functionality. The controller 31 may rely on one or more data maps relating to the operating conditions of the machine 10 that may be stored in the memory of controller. Each of these data maps may include a collection of data in the form of tables, graphs, and/or equations.

The control system 30 may be located on the machine 10 and may also include components located remotely from the machine such as at a command center 103. The functionality of control system 30 may be distributed so that certain functions are performed at machine 10 and other functions are performed remotely. In such case, the control system 30 may include a communications system such as wireless network system 104 for transmitting signals between the machine 10 and a system located remote from the machine.

A position sensing system 32, as shown generally by an arrow in FIG. 1 indicating association with the machine 10, may include a position sensor 33 that operates to sense a position of the machine relative to the work site 100. The position sensor 33 may include a plurality of individual sensors that cooperate to provide position signals to controller 31 to indicate the position of the machine 10. In one example, the position sensor 33 may include one or more sensors that interact with a positioning system such as a global navigation satellite system or a global positioning system to operate as a position sensor. The controller 31 may determine the position of the machine 10 within work site 100 as well as the orientation of the machine such as its heading, pitch and roll. In other examples, the position sensor 33 may be an odometer or another wheel rotation sensing sensor, a perception based system, or may use other systems such as lasers, sonar, or radar to determine the position of the machine 10.

Machine 10 may also include a drive speed sensing system 34, as shown generally by an arrow in FIG. 1 indicating association with the machine 10, that operates to sense a speed of the machine. The drive speed sensing system 34 may include a speed sensor 35 (FIG. 2) for generating speed signals indicative of the speed of the machine 10. Controller 31 may utilize the speed signals to determine the speed of the machine 10 relative to work surface 102. In one example, the speed sensor 35 may be a magnetic sensor associated with second motor 21, which is used to drive the deflectable tires 15. In another embodiment, controller 31 may utilize data from the position sensing system 32 to determine the speed of the machine.

Machine 10 may also include an inclination sensing system 36, as shown generally by an arrow in FIG. 1 indicating association with the machine 10, for determining the inclination or pitch angle of the machine relative to a level ground reference (i.e., perpendicular to the direction of gravity). The inclination sensing system may include an inclination or pitch angle sensor 37 for generating pitch angle signals that are used by controller 31 to determine the inclination or pitch angle of machine 10. In some embodiments, the inclination sensing system 36 may use a pitch rate sensor 38 in addition to or instead of the pitch angle sensor 37 to determine the pitch angle of the machine 10.

Machine 10 may also include various sensors associated with the drive system 14. For example, the machine 10 may include a power loss measurement system 40 for determining the amount of power lost or used during a compaction operation of the machine. The power loss measurement system 40 may include a power loss sensor 41 for generating signals indicative of power loss of the machine during a compaction operation. In one embodiment, the power loss sensor 41 may embody motor hydraulic sensors 42 (FIG. 2) to measure the difference between the hydraulic pressure within the first hydraulic line 22 and second hydraulic line 23 at the input and output of each of the first motor 20 and the second motor 21. The amount of power used to compact the work material 101 may be calculated based upon the change in hydraulic pressure between the input and the output of each of the first motor 20 and the second motor 21 together with the flow rate of the hydraulic fluid. In one example, the flow rate of hydraulic fluid through the first motor 20 and the second motor 21 may be determined by using speed sensor 35 to determine the speed of the machine 10 and determine the flow rate through the first motor 20 and the second motor 21 based upon the speed of the machine.

In another embodiment, the drive system 14 may include a mechanical drive with a torque converter (not shown). In such case, the power loss sensor 41 may include sensors that are used to determine the input speed of the torque converter (or the output speed of engine 13) and the output speed of the torque converter. The amount of power used to compact the work material 101 may be calculated based upon the change in speed between the input and the output of the torque converter.

Control system 30 may include a state of compaction system 45 for determining the level or state of compaction of work material 101 as machine 10 moves over the work surface 102. As the machine 10 moves along the work surface 102, power is used to compact the work material 101, to move the machine, and to overcome friction losses of the machine, and power is gained or lost depending on whether the machine is traveling down or up a grade. The state of compaction system 45 generally operates based upon the concept that less power is required to move a machine across a harder or more compacted work material 101 as compared to a softer or less compacted work material. By determining the actual drive power (P_{Actual}) used by the machine 10 as it moves along the work surface 102 and compacts the work material 101, a relative state of compaction of the work material may be determined. As a result, the actual drive power P_{Actual}) is directly proportional to the softness or state of compaction of the work surface 102.

The actual drive power (P_{Actual}) may be generally represented by the equation:

P_{Actual}=P_{Gross}−P_{Grade}−P_{Friction} (1)

where P_{Gross} is gross amount of power used to propel the machine 10 along the work surface 102, P_{Grade} is the change in power due to the change in elevation or grade of the machine, and P_{Friction} is the power lost due to friction and other losses associated with the machine as it moves. The change in power due to a change in elevation (P_{Grade}) will increase as the slope upon which the machine 10 is traveling increases and will decrease as the slope decreases. In general, the friction power loss (P_{Friction}) will increase as the speed of the machine 10 increases.

In some instances, the change in power due to a change in elevation (P_{Grade}) and the friction power loss (P_{Friction}) may be combined to define a lumped or summed power change (P_{Lumped}). As a result, Equation (1) may be re-written as:

P_{Actual}=P_{Gross}−P_{Lumped} (2)

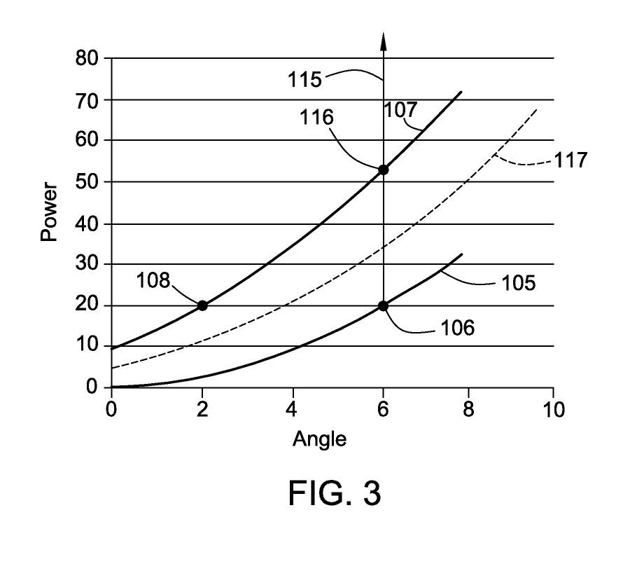

Operation of the machine 10 on a soft work surface 102 may be equated to or modeled after the operation of the machine on a hard work surface but with the machine moving up or climbing a slope or angle. Referring to FIG. 3, a first curve 105 depicts an example of the gross amount of power (P_{Gross}) used to propel the machine 10 along a constant density or hardness hard work surface as a function of the slope or pitch angle and at a constant speed. A second curve 107 depicts an example of the gross amount of power (P_{Gross}) used to propel the machine 10 along a constant density or hardness soft work surface as a function of the slope or pitch angle and at the same constant speed. In this example, it may be seen that the gross amount of power required to move the machine 10 on a hard surface at a six degree slope as indicated at 106 is approximately equal to the gross amount of power required to move the machine 10 on a two degree slope as indicated at 108. As a result, the operation of the machine 10 on the soft surface as specified in FIG. 3 may be approximated to the operation of the machine on a hard surface by adding a slope of four degrees to the analysis.

In an alternative model or explanation of the relationship between first curve 105 and second 107, the power to operate on any surface at a fixed speed and angle will vary depending on the hardness or density of the material. More specifically, the power will be at a minimum power on a hard work surface corresponding to first curve 105 and increase along a vertical axis as the work surface becomes softer. For example, axis 115 depicts the gross amount of power (P_{Gross}) used to propel the machine 10 along the work surface for a fixed speed and angle. The gross amount of power (P_{Gross}) used to propel the machine 10 is at a minimum on the hard work surface corresponding to first curve 105 such as at point 106 and increases along axis 115 such that the gross amount of power is higher as one moves up axis 115 and the work surface becomes softer. Thus, the gross amount of power (P_{Gross}) used to propel the machine 10 along the work surface corresponding to curve 107 such as at point 116 is thus higher than that at point 106.

The alternative model provides a density correlation between net power or actual drive power (P_{Actual}) and the gross amount of power (P_{Gross}) at a given speed and angle. For example, a work surface 102 having an actual drive power (P_{Actual}) halfway between first curve 105 and second curve 107 is depicted in phantom at 117. The density or hardness of the work surface 102 along axis 115 for the same speed and angle is halfway between density of first curve 105 and second curve 107 as well. For each different speed and angle, the ratiometric relationship still holds but the axis 115 will be shifted and extends upward from the new speed and angle coordinate point.

It has been determined by empirical data that the change in the gross amount of power (P_{Gross}) required or used as the machine moves along the work surface is, in general, directly proportional to the change in actual drive power (P_{Actual}) due to the compaction of the work surface when operating at the same slope and speed. In other words, when operating at a specified slope and speed, a change in the gross amount of power (P_{Gross}) used will result in a proportional change in actual drive power (P_{Actual}). As set forth in more detail below, by monitoring the gross amount of power (P_{Gross}) used to propel the machine 10, the actual drive power (P_{Actual}) attributable to the compaction of the work surface 102 may be determined for a particular portion of the work site 100.

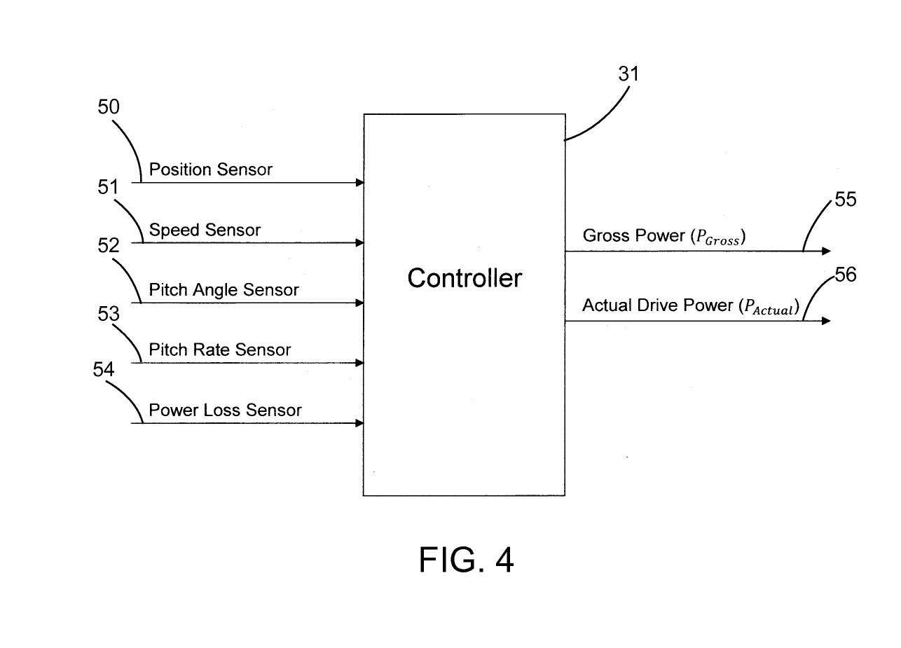

As depicted in FIG. 4, the controller 31 receives information from various sensors and processes this information. Controller 31 may receive, at a first input node 50 position signals from position sensor 33, speed signals from speed sensor 35 at a second input node 51, and inclination signals from the pitch angle sensor 37 at a third input node 52. If a pitch rate sensor 38 is included, the controller 31 may receive pitch rate signals from the pitch rate sensor at a fourth input node 53. At a fifth input node 54, the controller 31 may receive signals from power loss sensor 41 indicative of power loss that occurs during a compacting operation.

Controller 31 may generate various output signals based upon the operation of the state of compaction system 45. For example, at a first output node 55, the controller 31 may generate signals indicative of the gross amount of power (P_{Gross}) used to propel the machine 10 along the work surface 102. At a second output node 56, the controller 31 may use the gross amount of power (P_{Gross}) used and, the speed and pitch angle of the machine 10 to generate signals indicative of the actual drive power (P_{Actual}) used for compaction and thus determine and display the state of compaction of the work material 101.

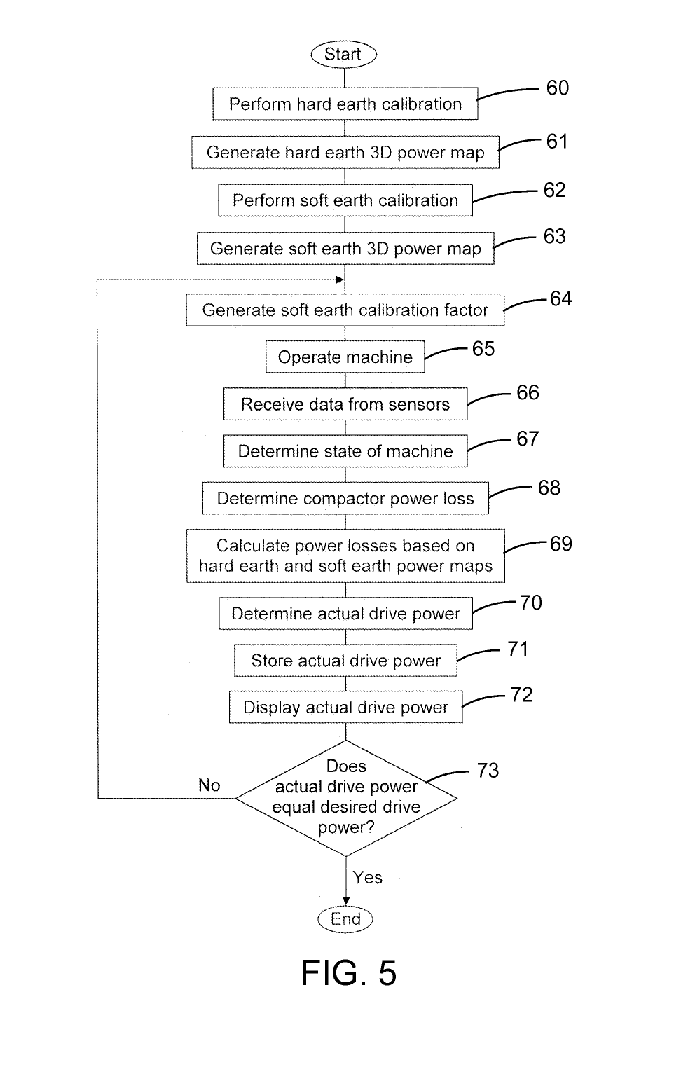

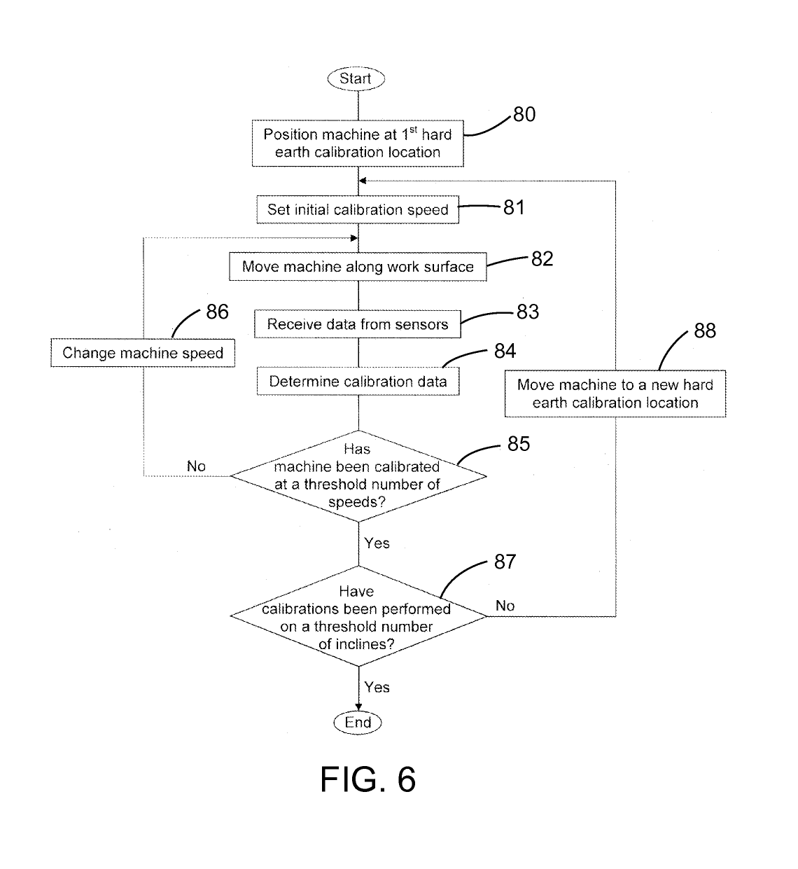

FIG. 5 depicts a flowchart of the operation of the state of compaction system 45 in conjunction with the operation of machine 10. At stage 60, a hard earth calibration may be performed to determine a baseline for the gross power loss characteristics of the machine 10. Referring to FIG. 6, a flowchart of the hard earth calibration process is depicted. At stage 80, the machine 10 is positioned on a hard earth calibration surface at a first location. The hard earth calibration surface is a surface that does not deflect or compact under the weight of the machine as would occur with a compactable work material. As a result, the power required to move the machine 10 along such a calibration surface does not include any energy used to compact the work material. The power used as the machine 10 moves along the calibration surface thus accurately reflects the lumped power change (P_{Lumped}) including the friction losses of the machine required to move the machine such as the rolling resistance and other losses together with power losses or gains as the machine moves uphill or downhill during the calibration process.

An initial calibration speed may be set or stored within controller 31 at stage 81. The machine 10 may be moved along the hard earth calibration surface 102 at stage 82 at a constant speed equal to the initial calibration speed and at a constant slope. In one example, the machine 10 may be moved in forward and then in reverse to obtain data with the machine moving in opposite directions.

At stage 83, the controller 31 may receive data from the various sensors of the machine. The controller 31 may determine at stage 84 hard earth calibration data such as the speed of the machine 10, the pitch angle of the machine, and the gross amount of power (P_{Gross}) used to propel the machine along the calibration surface. At decision stage 85, the controller 31 may determine whether the machine 10 has been moved along the hard earth calibration surface at a threshold number of different speeds for the pitch angle or slope on which the machine is moving. If the machine 10 has not been moved along the hard earth calibration surface at a sufficient number of speeds, the controller 31 may at stage 86 change the speed of the machine and the process of stages 82-85 repeated. In one example, the power losses may be determined by operating the machine 10 at a series of different speeds (e.g., 1 kph, 2 kph, 3 kph, 4 kph, etc.) while using the power loss measurement system 40 to determine the amount of power required to move the machine at each of those speeds.

If the machine 10 has been moved along the hard earth calibration surface at a sufficient number of speeds, the controller 31 may at decision stage 87 determine whether has been moved along the hard earth calibration surface at a threshold number of different pitch angles or slopes. If the machine 10 has not been moved along the hard earth calibration surface at a sufficient number of pitch angles, the controller 31 may at stage 88 move the machine to a new location with a hard earth calibration surface having a different pitch angle and the process of stages 81-87 repeated.

It should be noted that, in some instances, the hard earth calibration location may not permit the machine 10 to be moved at a constant angle but the system disclosed herein may still be used to perform the hard earth calibration process. To do so, the machine 10 may be moved about the hard earth calibration surface at the hard earth calibration location and the controller may record the pitch angle, the speed, and the gross amount of power (P_{Gross}) used to propel the machine as the machine moves along the hard earth calibration surface.

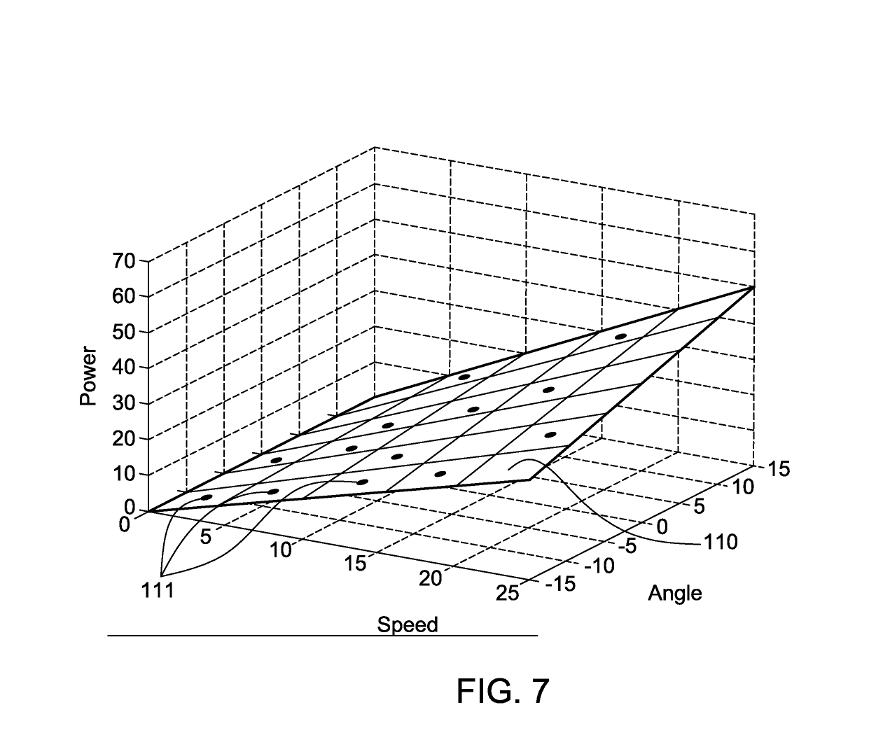

Referring back to FIG. 5, after the machine 10 has been moved along the hard earth calibration surface at a sufficient number of pitch angles and at a sufficient number of speeds, the controller 31 may at stage 61 generate a three-dimensional hard earth power map 110 (FIG. 7) based upon the hard earth calibration data generated in accordance with FIG. 6 as the machine 10 is moved along the hard earth calibration surface. More specifically, as the machine 10 is moved along the hard earth calibration surface, the speed and pitch angle of the machine together with the gross amount of power (P_{Gross}) used to propel the machine define a hard earth calibration data point 111. As the machine 10 is moved at different speeds and different pitch angles, additional hard earth calibration data points 111 are defined to create a set or plurality of hard earth calibration data points 111.

Controller 31 may use any desired process to form the three-dimensional hard earth power map 110 that maps the gross amount of power (P_{Gross}) used as the machine moves along the work surface 102 as a function of the slope upon which the machine 10 is moving and the speed of the machine. In one example, a least squares method may be used to determine the three-dimensional hard earth power map. In doing so, the three-dimensional hard earth power map 110 may take the form of:

P_{Gross}=C₁+C₂*Spd+C₃*PA+C₄*Spd²+C₅*Spd*PA (3)

where C₁-C₅ are constants, Spd is the speed of the machine 10, and PA is the pitch angle of the machine.

At stage 62, a soft earth calibration may be performed to determine a soft earth calibration factor (SECF) that may be subsequently used to determine the actual drive power (P_{Actual}) at any location at the work site 100 and thus estimate the state of compaction of the work surface 102. To perform the soft earth calibration process, the machine 10 may be moved to a soft earth calibration surface of the work site 100 at which the state of compaction of the work material 101 or the actual drive power (P_{Actual}) is known. In some instances, the machine operator or other personnel may prepare or condition the work material in a desired manner and then perform one or more tests to determine the actual drive power (P_{Actual}) setting or reading for the work material 101 at the soft earth calibration surface.

As the machine 10 moves over the area of known compaction, controller 31 may determine the gross amount of power (P_{Gross}) used to propel the machine together with the speed and pitch angle of the machine. Each of these values together with the actual drive power (P_{Actual}) may be stored as a soft earth calibration data point.

If desired, more than one soft earth calibration data point may be generated as the machines move along the area of known compaction. In such case, the controller 31 may generate an average of the soft earth calibration data points, select a data point that is most representative of the soft earth calibration process, or use another method to generate a soft earth calibration data point.

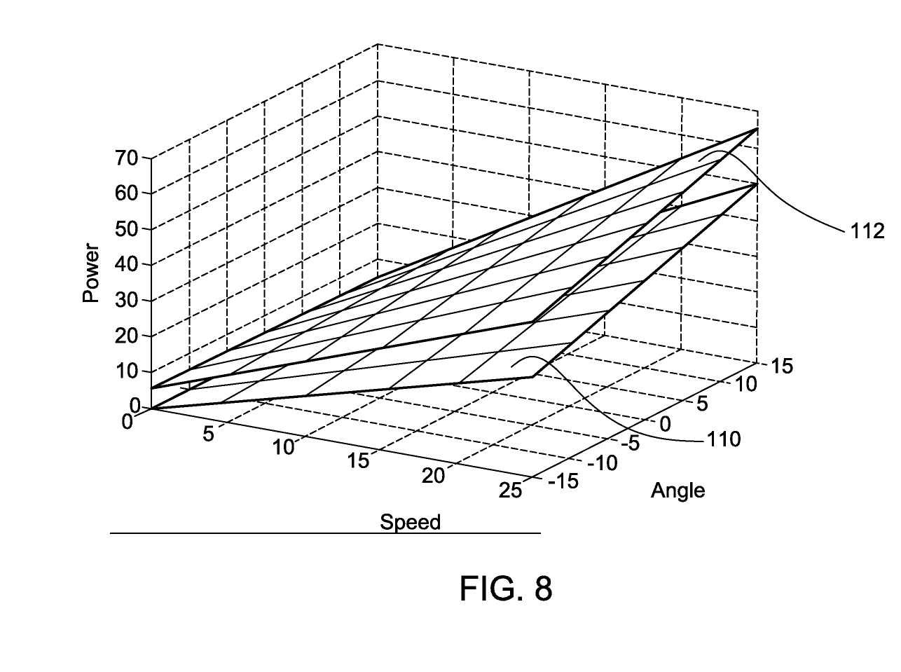

At stage 63, a three-dimensional soft earth power map 112 (FIG. 8) may be created that generally follows the three-dimensional hard earth power map 110 but is shifted by an angle to approximate the machine 10 moving up a slope. The controller 31 may calculate the gross amount of power (P_{Advanced}) required to move the machine along the work surface 102 based upon the three-dimensional soft earth power map 112 but at the slope and speed corresponding to the soft earth calibration data point.

As stated above, the change in the gross amount of power (P_{Gross}) required or used as the machine moves along the work surface is, in general, directly proportional to the change in actual drive power (P_{Actual}) due to the compaction of the work surface when operating at the same slope and speed. Accordingly, to determine the shift in pitch angle necessary to compensate for soft material, a soft earth calibration factor (SECF) may be generated at stage 64 that may be subsequently used to determine the actual drive power (P_{Actual}) at any location on the work surface 102. To do so, the ratio of the gross powers and actual drive powers may be written in terms of the actual drive power P_{Gross(Advanced)} determined by the three-dimensional soft earth power map 112 at the slope and speed corresponding to the soft earth calibration point as follows:

$${P}_{Actual ( Advanced )} = {P}_{Actual ( Hard )} - [ ( {P}_{Actual ( Hard )} - {P}_{Actual ( Soft )} ) \frac{{P}_{Gross ( Advanced )} - {P}_{Gross ( Hard )}}{{P}_{Gross ( Soft ) - {P}_{Gross ( Hard )}}} ] \qquad ( 4 )$$

where P_{Actual(Hard)} is the actual drive power at the hard earth calibration location, P_{Actual(Soft)} is the actual drive power at the soft earth calibration location, P_{Advanced} is the gross amount of power used to move the machine along the work surface 102 based upon the three-dimensional soft earth power map 112 at the slope and speed corresponding to the soft earth calibration data point, P_{Gross(Hard)} is the gross amount of power used to move the machine along the work surface 102 during the hard earth calibration process at the slope and speed corresponding to the soft earth calibration data point as determined from the three-dimensional hard earth power map 110, and P_{Gross(Soft)} is the gross amount of power used to move the machine along the work surface 102 during the soft earth calibration process at the slope and speed corresponding to the soft earth calibration data point.

The actual drive power (P_{Actual (Advanced)}) determined by the three-dimensional soft earth power map 112 at the slope and speed corresponding to the soft earth calibration data point may then be set as the soft earth calibration factor (SECF). The soft earth calibration factor (SECF), establishes a relationship between the state of compaction or actual drive power required due to the compaction of the work surface 102 along the three-dimensional soft earth power map 112 and the three-dimensional hard earth power map 110. The soft earth calibration factor (SECF) may be used to determine the state of compaction or actual drive power (P_{Actual(Current)}) required due to the compaction of the work surface 102 at any location at the work site 100. More specifically, the proportionality of the change in the gross amount of power (P_{Gross}) required or used as the machine moves along the work surface to the change in actual drive power (P_{Actual)} due to the compaction of the work surface when operating at the same slope and speed may be used to generate an equation for the state of compaction or actual drive power P_{Actual (Current)} as follows:

$${P}_{Actual ( Current )} = {P}_{Actual ( Hard )} + [ ( S E C F - {P}_{Actual ( Hard )} ) \frac{{P}_{Gross ( Current )} - {P}_{Gross ( Hard )}}{{P}_{Gross ( Advanced ) - {P}_{Gross ( Hard )}}} ] \qquad ( 5 )$$

where P_{Actual(Current)} is the actual drive power required due to the compaction of the work surface at the current location of the machine 10, P_{Actual(Hard)} is the actual drive power at the hard earth calibration location, SECF is the soft earth calibration factor, P_{Gross(Current)} is the gross amount of power used to move the machine along the work surface 102 at the current location of the machine, P_{Gross(Hard)} is the hard earth gross amount of power used to move the machine along the work surface 102 at the slope and speed corresponding to the current location as determined from the three-dimensional hard earth power map 110, and P_{Gross(Advanced)} is the soft earth gross amount of power used to move the machine along the work surface 102 at the slope and speed corresponding to the current location as determined from the three-dimensional soft earth power map 112.

At stage 65, the machine 10 may be moved to another location at the work site 100 and the compaction operation begun. As the machine 10 operates, the controller 31 may receive data from the various sensors at stage 66. At stage 67, the controller 31 may determine the state of the machine 10. More specifically, the controller 31 may determine the position of the machine 10 based upon position signals from the position sensing system 32 and determine the speed at which the machine is operating based upon speed signals from the drive speed sensing system 34. In addition, the controller 31 may also determine the pitch angle or inclination of the machine 10 based upon inclination signals from the inclination sensing system 36.

At stage 68, the controller 31 may determine the gross amount of power (P_{Gross}) used to propel the machine 10 along the work surface 102 as the machine 10 moves about the work site 100. In doing so, the controller 31 may utilize the power loss measurement system 40 as described above. In still another embodiment, the power loss measurement system 40 may measure the difference between the input and the output of a torque converter used to drive the machine 10.

At stage 69, the controller 31 may determine power losses based upon the three-dimensional hard earth power map 110 and the three-dimensional soft earth power map 112. More specifically, the controller 31 may determine the gross amount of power (P_{Gross(Hard)}) used to move the machine 10 along the work surface 102 at the slope and speed corresponding to the current location as determined from the three-dimensional hard earth power map 110. The controller 31 may also determine the gross amount of power (P_{Gross(Advanced)}) used to move the machine along the work surface 102 at the slope and speed corresponding to the current location as determined from the three-dimensional soft earth power map 112.

At stage 70, the controller 31 may determine the actual drive power (P_{Actual}) according to equation (5) for the current location of the machine 10 where the actual drive power (P_{Actual(Hard)}) at the hard earth calibration location is determined at stage 60, the soft earth calibration factor (SECF) is determined at stage 64, the gross amount of power (P_{Gross (Current)}) used to move the machine at the current location is determined at stage 68, the gross amount of power (P_{Gross(Hard)}) used to move the machine as determined from the three-dimensional hard earth power map 110 is determined at stage 69, and the gross amount of power (P_{Gross(Advanced)}) used to move the machine as determined from the three-dimensional soft earth power map 112 is also determined at stage 69.

The actual drive power (P_{Actual(Current)}) at the current location may be stored at stage 71 and displayed on display 29 at stage 72. At decision stage 73, the controller 31 may determine whether the actual drive power (P_{Actual(Current)}) is equal to a desired drive power. If the actual drive power (P_{Actual(Current)}) is not equal the desired drive power, the operator may continue to operate machine 10 and the process of stages 65-73 repeated. If the actual drive power (P_{Actual(Current)}) does equal the desired drive power at decision stage 73, the operator may move the machine 10 to a new location and begin a new compacting process, if desired.

### INDUSTRIAL APPLICABILITY

The industrial applicability of the system described herein will be readily appreciated from the forgoing discussion. The foregoing discussion is applicable to machines 10 such as compactors that engage the work surface 102 above a work material 101 to compact the material to prepare it for a subsequent use or otherwise reduce its volume. Such system may be used at a construction site, a roadwork site, a mining site, a landfill, or any other area in which compaction of work material 101 is desired. Work material 101 may include any material such as asphalt, gravel, soil, sand, landfill trash, and other types of material.

When compacting a work material 101, it may be desirable to determine the state of compaction of the work material. The state of compaction system 45 is operative to utilize data from the sensors as well as the characteristics of the machine 10 to determine the state of compaction of the work material 101. The state of compaction system 45 may be used by performing a hard earth calibration process on a plurality of slopes and at a plurality of speeds. The gross amount of power (P_{Gross}) used during the hard earth calibration process may be recorded within controller 31 together with the corresponding slopes and speeds. The controller 31 may generate a three-dimensional hard earth power map 110 based upon the gross amount of power (P_{Gross}) used during the hard earth calibration process and the corresponding slopes and speeds.

In addition to performing the hard earth calibration process, the state of compaction system 45 may also use a soft earth calibration process. The gross amount of power (P_{Gross}) used as the machine 10 moves along an area of soft earth having a known level or extent of compaction may be recorded within controller 31 together with the slope and speed of the machine. The soft earth calibration process may be performed based upon one or more sets of date points. The soft earth calibration process may be used to generate a soft earth calibration factor that may then be used with the three-dimensional hard earth power map 110 to determine the state of compaction for any location at the work site 100. An electronic map of the work site 100 including the state of compaction may be generated and stored within controller 31 and/or at a remote location.

It will be appreciated that the foregoing description provides examples of the disclosed system and technique. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A system for determining a state of compaction of a work material during a compaction operation, comprising:
a roller associated with a machine and configured to engage and compact the work material;
a speed sensor associated with the machine operative to determine a speed of the machine;
a pitch angle sensor associated with the machine operative to determine a pitch angle of the machine;
a power loss sensor associated with the machine operative to determine a power loss of the machine; and
a controller configured to:
determine a plurality of hard earth calibration data points based upon the speed of the machine, the pitch angle of the machine, and the power loss of the machine as the machine moves along a hard earth calibration surface, the plurality of hard earth calibration data points corresponding to a plurality of different speeds and a plurality of different pitch angles;
determine a three-dimensional hard earth power map based upon the plurality of hard earth calibration data points;
determine at least one soft earth calibration data point based upon the speed of the machine, the pitch angle of the machine, and the power loss of the machine as the machine moves along a soft earth calibration surface;
determine a soft earth calibration factor based upon the at least one soft earth calibration data point; and
determine the state of compaction of the work material based upon the speed of the machine, the pitch angle of the machine, the three-dimensional hard earth power map, and the soft earth calibration factor as the machine moves along the work material.

2. The system of claim 1, wherein the controller is further configured to determine a three-dimensional soft earth power map and determine the state of compaction of the work material further based upon the three-dimensional soft earth power map.

3. The system of claim 2, wherein the controller is further configured to determine the three-dimensional soft earth power map based upon the three-dimensional hard earth power map and the soft earth calibration factor.

4. The system of claim 2, wherein the controller is configured to:
determine a hard earth gross amount of power used based upon the three-dimensional hard earth power map, the speed of the machine, and the pitch angle of the machine;
determine a soft earth gross amount of power used based upon the three-dimensional soft earth power map, the speed of the machine, and the pitch angle of the machine; and
further determine the state of compaction of the work material based upon the hard earth gross amount of power used and the soft earth gross amount of power used.

5. The system of claim 2, wherein the three-dimensional soft earth power map is generally identical to the three-dimensional hard earth power map but shifted relative to a pitch angle of the machine.

6. The system of claim 1, wherein the controller is configured to determine the soft earth calibration factor based upon only one soft earth calibration data point.

7. The system of claim 1, wherein the controller is configured to determine the soft earth calibration factor based upon a plurality of soft earth calibration data points.

8. The system of claim 1, further including a position sensor associated with the machine operative to determine a position of the machine and the controller is further configured to store the state of compaction together with the position of the machine.

9. The system of claim 1, wherein the machine further includes a hydrostatic system having a pump operatively connected to a motor, and the motor is operatively connected to the roller.

10. The system of claim 9, wherein the controller is further configured to determine the power loss based upon a difference between an input and an output of the motor.

11. The system of claim 1, wherein the machine further includes a torque converter, and the controller is further configured to determine the power loss based upon a difference between an input and an output of the torque converter.

12. A controller-implemented method for determining a state of compaction of a work material during a compaction operation, comprising:
moving a machine along a along a hard earth calibration surface at plurality of different speeds and a plurality of different pitch angles;
determining a plurality of hard earth calibration data points based upon a speed of the machine, a pitch angle of the machine, and a power loss of the machine as the machine moves along the hard earth calibration surface, the plurality of hard earth calibration data points corresponding to the plurality of different speeds and the plurality of different pitch angles;
determining a three-dimensional hard earth power map based upon the plurality of hard earth calibration data points;
moving the machine along a soft earth calibration surface;
determining at least one soft earth calibration data point based upon the speed of the machine, the pitch angle of the machine, and the power loss of the machine as the machine moves along a soft earth calibration surface;
determining a soft earth calibration factor based upon the at least one soft earth calibration data point; and
moving the machine along the work material;
determining the state of compaction of the work material based upon the speed of the machine, the pitch angle of the machine, the three-dimensional hard earth power map, and the soft earth calibration factor as the machine moves along the work material.

13. The method of claim 12, further including determining a three-dimensional soft earth power map and determining the state of compaction of the work material further based upon the three-dimensional soft earth power map.

14. The method of claim 13, further including determining the three-dimensional soft earth power map based upon the three-dimensional hard earth power map and the soft earth calibration factor.

15. The method of claim 13, further including determining:
a hard earth gross amount of power used based upon the three-dimensional hard earth power map, the speed of the machine, and the pitch angle of the machine;
a soft earth gross amount of power used based upon the three-dimensional soft earth power map, the speed of the machine, and the pitch angle of the machine; and
the state of compaction of the work material based upon the hard earth gross amount of power used and the soft earth gross amount of power used.

16. The method of claim 13, further including determining the three-dimensional soft earth power map by shifting the pitch angle of the three-dimensional hard earth power map.

17. The method of claim 12, further including determining the soft earth calibration factor based upon only one soft earth calibration data point.

18. The method of claim 12, further including determining the soft earth calibration factor based upon a plurality of soft earth calibration data points.

19. The method of claim 12, further including determining a position of the machine and storing the state of compaction together with the position of the machine.

20. A machine comprising:
a prime mover;
a roller associated with a machine and configured to engage and compact a work material;
a speed sensor associated with the machine operative to determine a speed of the machine;
a pitch angle sensor associated with the machine operative to determine a pitch angle of the machine;
a power loss sensor associated with the machine operative to determine a power loss of the machine; and
a controller configured to:
determine a plurality of hard earth calibration data points based upon the speed of the machine, the pitch angle of the machine, and the power loss of the machine as the machine moves along a hard earth calibration surface, the plurality of hard earth calibration data points corresponding to a plurality of different speeds and a plurality of different pitch angles;
determine a three-dimensional hard earth power map based upon the plurality of hard earth calibration data points;
determine at least one soft earth calibration data point based upon the speed of the machine, the pitch angle of the machine, and the power loss of the machine as the machine moves along a soft earth calibration surface;
determine a soft earth calibration factor based upon the at least one soft earth calibration data point; and
determine a state of compaction of the work material based upon the speed of the machine, the pitch angle of the machine, the three-dimensional hard earth power map, and the soft earth calibration factor as the machine moves along the work material.
